(19) United States
(12) Patent Application Publication
(10) Pub. No.: US 2008/0209213 A1
(43) Pub. Date: Aug. 28, 2008

(54) AUTHORIZING SECURE RESOURCES

(75) Inventors: Per Astrand, Lund (SE); Bengt Gunnar Stavenow, Lund (SE)

Correspondence Address: HARRITY SNYDER, L.L.P., 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 11/678,426

(22) Filed: Feb. 23, 2007

(51) Int. Cl. H04L 9/00

(52) U.S. Cl. 713/168

(57) ABSTRACT

A system receives a request to access a secure resource and a verification telephone number from a first device, establishes a secure session with a second device associated with the verification telephone number, requests an authentication mechanism from the second device to verify the secure resource request, verifies the received authentication mechanism if the requested authentication mechanism is received from the second device, and determines whether to grant or deny the first device access to the secure resource based on the verification of the received authentication mechanism.

### BACKGROUND

An individual may own a number of resources he/she would like to potentially grant other parties access to in a controlled manner. Organizations are continuously looking to prevent access to their internal network resources from untrustworthy endpoints (e.g., unauthenticated devices connected to the networks). There may be a number of situations where an individual and/or organization may wish to dynamically control access to a secure resource, as well as have control over when and/or how the secure resource is being accessed. For example, an individual may allow their children to access their credit card (i.e., a secure resource), but would like to be notified and approve a transaction when a request for a purchase is made with the credit card by the children. In another example, an organization may permit an employee to access certain portions of an internal network, but may deny the same employee access to other portions of the internal network.

### SUMMARY

According to one aspect, a method may include receiving a request to access a secure resource and a verification telephone number from a first device, establishing a secure session with a second device associated with the verification telephone number, requesting an authentication mechanism from the second device to verify the secure resource request, verifying the received authentication mechanism if the requested authentication mechanism is received from the second device, and determining whether to grant or deny the first device access to the secure resource based on the verification of the received authentication mechanism.

Additionally, the method may include associating the verification telephone number with the authentication mechanism.

Additionally, establishing a secure session may include generating a Short Message Service (SMS) signal that includes an address for establishing the secure session, providing the SMS signal to the second device, and establishing the secure session if the second device accesses the address.

Additionally, verifying the received authentication mechanism may include determining whether the received authentication mechanism matches an authentication mechanism associated with the verification telephone number.

According to another aspect, a method may include receiving a request to use a secure resource, determining a device associated with the secure resource, establishing a secure session with the device associated with the secure resource, requesting approval of the secure resource request from the device, verifying the approval if the approval of the secure resource request is received from the device, and determining whether to grant or deny the first device use of the secure resource based on the verification of the approval.

Additionally, establishing a secure session may include generating a Short Message Service (SMS) signal that includes an address for establishing the secure session, providing the SMS signal to the device, and establishing the secure session if the device accesses the address.

Additionally, requesting approval may include providing a description of the secure resource to the device, and requesting signature of the description by the device with a private key.

Additionally, verifying the approval may include verifying the approval with a public key associated with the device.

According to yet another aspect, a method implemented within a first device may include receiving a Short Message Service (SMS) signal that includes an address for establishing a secure session to authenticate a request to access a secure resource by a second device, establishing the secure session based on the address, receiving a request for an authentication mechanism to authenticate the secure resource request, and providing the requested authentication mechanism if the secure resource request is to be authenticated.

Additionally, the method may include receiving an indication of whether access to the secure resource is granted or denied to the second device.

Additionally, receiving a request for an authentication mechanism may include receiving a description of the secure resource.

According to a further aspect, a method implemented within a first device may include receiving a Short Message Service (SMS) signal that includes an address for establishing a secure session to approve a request to use a secure resource by a second device, establishing the secure session based on the address, receiving a request for approval of the secure resource request, and providing the requested approval if the secure resource request is to be approved.

Additionally, the method may include receiving an indication of whether approval to use the secure resource is granted or denied to the second device.

Additionally, receiving a request for approval may include receiving a description of the secure resource, and receiving a request for signature of the description with a private key.

Additionally, providing the requested approval may include providing the description signed with the private key if the secure resource request is to be approved.

Additionally, receiving a request for approval may include at least one of receiving a description of the secure resource, receiving an identification of a user requesting use of the secure resource, or receiving a random number identifying the secure resource request.

According to another aspect, a method implemented within a first device may include requesting access to or use of a secure resource, providing a verification telephone number identifying a second device, the second device authenticating the first device for access to or use of the secure resource, and receiving access to or use of the secure resource based on the authentication provided by the second device.

According to a further aspect, a system may include means for receiving a request to access a secure resource from a first device, means for establishing a secure session, via a Short Message Service (SMS) signal, with a second, different device to authorize access to the secure resource, means for requesting approval of the secure resource request from the second device, means for verifying the approval if the approval of the secure resource request is received from the second device, and means for determining whether to grant or deny the first device access to the secure resource based on the verification of the approval.

Additionally, the means for requesting approval may include one of means for requesting an authentication mechanism from the second device to verify the secure resource request, or means for requesting signature of a description of the secure resource by the second device with a private key.

Additionally, the means for verifying the approval may include one of means for determining whether an authentication mechanism received from the second device matches an authentication mechanism associated with a verification telephone number of the second device, or means for verifying the approval with a public key associated with the second device.

According to still another aspect, a system may include means for receiving a Short Message Service (SMS) signal that includes an address for establishing a secure session to authenticate a request to access a secure resource by a second device, means for establishing the secure session based on the address, means for receiving a request for approval of the secure resource request, and means for providing the requested approval if the secure resource request is to be approved.

Additionally, the means for receiving a request may include means for receiving a request for an authentication mechanism to authenticate the secure resource request.

Additionally, the means for providing the requested approval may include means for providing the requested authentication mechanism if the secure resource request is to be authenticated.

Additionally, the means for receiving a request for approval may include means for receiving a description of the secure resource and at least one of an identification of a user requesting use of the secure resource or a random number identifying the secure resource request, and means for receiving a request for signature of the description with a private key.

Additionally, the means for providing the requested approval may include means for providing the description signed with the private key if the secure resource request is to be approved.

According to another aspect, a device may include a memory to store a plurality of instructions, and a processor to execute instructions in the memory. The processor may receive a request to access a secure resource from a first device, establish a secure session, via a Short Message Service (SMS) signal, with a second, different device to authorize access to the secure resource, request approval of the secure resource request from the second device, verify the approval if the approval of the secure resource request is received from the second device, and determine whether to grant or deny the first device access to the secure resource based on the verification of the approval.

According to still another aspect, a device may include a memory to store a plurality of instructions, and processing logic to execute instructions in the memory. The processing logic may receive a Short Message Service (SMS) signal that includes an address for establishing a secure session to authenticate a request to access a secure resource by a second device, establish the secure session based on the address, receive a request for approval of the secure resource request, and provide the requested approval if the secure resource request is to be approved.

### BRIEF DESCRIPTION OF THE DRAWINGS

The accompanying drawings, which are incorporated in and constitute a part of this specification, illustrate one or more implementations described herein and, together with the description, explain these implementations. In the drawings:

FIG. 1 is an exemplary diagram of a network in which systems and methods described herein may be implemented;

FIG. 2 is an exemplary front view of the user device of FIG. 1;

FIG. 3 is a diagram of exemplary components of the user device of FIG. 2;

FIG. 4 is an exemplary diagram of the client or server of FIG. 1;

FIG. 5 is a diagram of exemplary displays that may be provided by the client of FIG. 1;

FIG. 6 is a diagram of exemplary displays that may be provided by the user device of FIG. 1; and

FIGS. 7-11 depict flow charts of exemplary processes according to implementations described herein.

### DETAILED DESCRIPTION

The following detailed description refers to the accompanying drawings. The same reference numbers in different drawings may identify the same or similar elements. Also, the following detailed description does not limit the invention.

### Overview

Implementations described herein may provide access to one or more secure resources based on authentication and/or authorization provided by a secure user device. For example, in one implementation, the user device may correspond to a cellular or mobile telephone capable of supporting a public key infrastructure (PKI). The user device may include two sets of PKI credentials (e.g., a private key and a public key or certificate) that provide authentication and/or authorization for another device (e.g., a client device) attempting to access a secure resource (e.g., a server provided in a secure network). The user of the user device may be the same as or different than the user of the client.

In one implementation (hereinafter referred to as an “authentication example”), a user of a device (e.g., a client) may request access to a secure resource (e.g., an application provided by a server of a secure network). The user, via the client, may provide a verification telephone number to authenticate the user. The secure resource request and the verification telephone number may be received by the server, and the server may generate a Short Message Service (SMS) signal that includes an address for establishing a secure session with the server. The SMS signal may be provided to a user device associated with the verification telephone number and the user, and a secure session may be established with the server. The server may associate the verification telephone number with an authentication mechanism (e.g., a user name, a password, a personal identification number (PIN), etc.), and may request the authentication mechanism from the user device to verify the secure resource request. The user device may provide the authentication mechanism to the server, and the server may verify the authentication mechanism in order to determine whether to grant or deny the client access to the secure resource. For example, if the user device provides the requested authentication mechanism, the user, via the client, may be granted access to the secure resource provided by the server.

In another implementation (hereinafter referred to as a “transaction example”), a person (e.g., an employee), via a device (e.g., a client), may request approval to use a secure resource (e.g., an application of a secure server that may require approval by a manager). The server may associate the secure resource with a telephone number and a public key related to a user device (e.g., to a user device of the manager). The server may send to the user device a SMS signal that includes an address for establishing a secure session with the server. If a secure session is established between the server and the user device, the server may send, to the user device, a description of the secure resource, the employee requesting approval, a request to approve use of the secure resource by the employee, and/or a random number identifying the request. The manager may approve the secure resource request, via the user device, by electronically signing the description of the secure resource with the private key and sending the signed description and the random number to the server. In order to determine whether to grant or deny the user access to the secure resource, the server may verify the signed description of the secure resource with a public key associated with the user device and/or by comparing the received random number with the original random number. For example, if the signed description is verified, the employee, via the client, may receive approval to use the secure resource.

A “secure resource,” as the term is used herein, is to be broadly interpreted to include any network, device, application, property, and/or combinations of networks, devices, applications, and/or properties to which access may be controlled. For example, a secure resource may include a secure or private network, an intranet, a local network, applications and/or devices provided in a secure network, an intranet, or a local network, a credit card, a vehicle (e.g., an automobile, a truck, an aircraft, a boat, etc.), a building, personal web pages, email accounts, any web site requiring a login, password, user name, etc., and/or any other network, device, application, and/or property which may require authorization and/or authentication.

### Exemplary Network Configuration

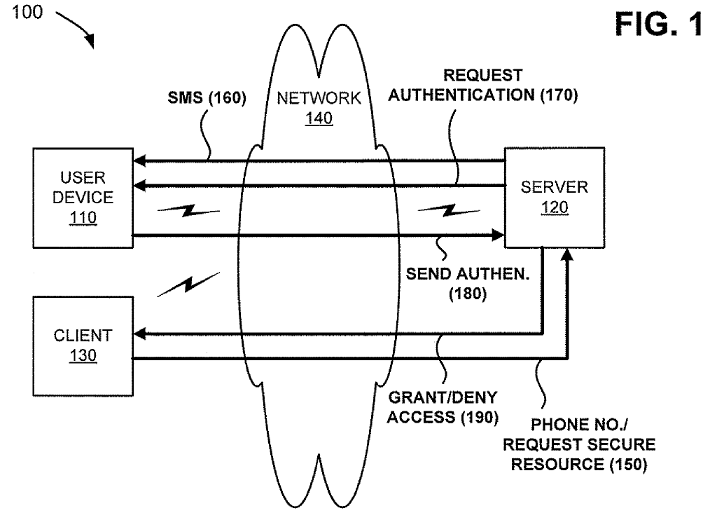

FIG. 1 is an exemplary diagram of a network 100 in which systems and methods described herein may be implemented. Network 100 may include a user device 110, a server 120, and a client 130 connected via a network 140. One user device 110, one server 120, and one client 130 have been illustrated as connected to network 140 for simplicity. In practice, there may be more user devices, servers, and/or clients. Also, in some instances, a user device may perform one or more functions of a server and a server may perform one or more functions of a user device. In other instances, a client may perform one or more functions of a server and a server may perform one or more functions of a client.

User device 110 may include one or more entities. An entity may be defined as a device, such as a telephone, a cellular phone (e.g., providing Internet-based applications, such as a Wireless Application Protocol (WAP) application), a personal computer, a personal digital assistant (PDA), a laptop, or another type of computation or communication device, a thread or process running on one of these devices, and/or an object executable by one of these devices. In one implementation, user device 110 may provide authorization and/or authentication of one or more secure resources in a manner described herein.

Server 120 may include one or more server entities that gather, process, search, and/or provide information in a manner described herein. For example, in one implementation, server 120 may provide one or more secure resources, and/or authorization/authentication of one or more secure resources in a manner described herein.

Client 130 may include one or more entities, such as a telephone, a cellular phone (e.g., providing Internet-based applications, such as a WAP application), a personal computer, a PDA, a laptop, a card authorization device (e.g., a credit or debit card authorization device, a key fob, etc.), or another type of computation or communication device, a thread or process running on one of these devices, and/or an object executable by one of these devices. In one implementation, client 130 may request access to and/or approval to use a secure resource in a manner described herein. In other implementations, client 130 may correspond to a second user device 110.

Network 140 may include a local area network (LAN), a wide area network (WAN), a metropolitan area network (MAN), a telephone network, such as the Public Switched Telephone Network (PSTN) or a cellular telephone network, an intranet, the Internet, or a combination of networks. User device 110, server 120, and client 130 may connect to network 140 via wired and/or wireless connections.

Although FIG. 1 shows exemplary components of network 100, in other implementations, network 100 may contain fewer, different, or additional components than depicted in FIG. 1.

As further shown in FIG. 1, in an exemplary operation, client 130 may send a request 150 to access a secure resource to server 120. In the authentication example, client 130 may provide a verification telephone number of user device 110 with request 150. The verification telephone number may be utilized to authorize and/or authenticate the user of client 130. In the transaction example, server 120 may determine a user device (e.g., user device 110) associated with the secure resource of request 150. Server 120 may generate a SMS signal 160 to establish a secure session with user device 110, and may send a request 170 for an authentication mechanism (e.g., a user name, a password, a PIN, etc.) to user device 110 if a secure session is established. In the authentication example, server 120 may associate the verification telephone number with the authentication mechanism, and may request the authentication mechanism from user device 110. In the transaction example, server 120 may provide a description of the secure resource to user device 110 and may request signature of the description by user device 110, via a private key.

As further shown in FIG. 1, user device 110 may provide an authentication mechanism 180 to server 120. In the authentication example, user device 110 may provide authentication mechanism 180 directly to server 120, and authentication mechanism 180 may be associated with the verification telephone number. Server 120 may receive authentication mechanism 180 and may verify authentication mechanism 180 (e.g., by comparing authentication mechanism 180 to the verification telephone number). In the transaction example, user device 110 may sign the secure resource description with a private key. Server 120 may receive the signed description and may verify the signed description of the secure resource with a public key associated with user device 110. In both the authentication and transaction examples, server 120 may send a signal 190 granting or denying access to the secure resource to client 130. For example, if client 130 is granted access to the secure resource, server 120 may provide client 130 access to the secure resource.

### Exemplary User Device Configuration

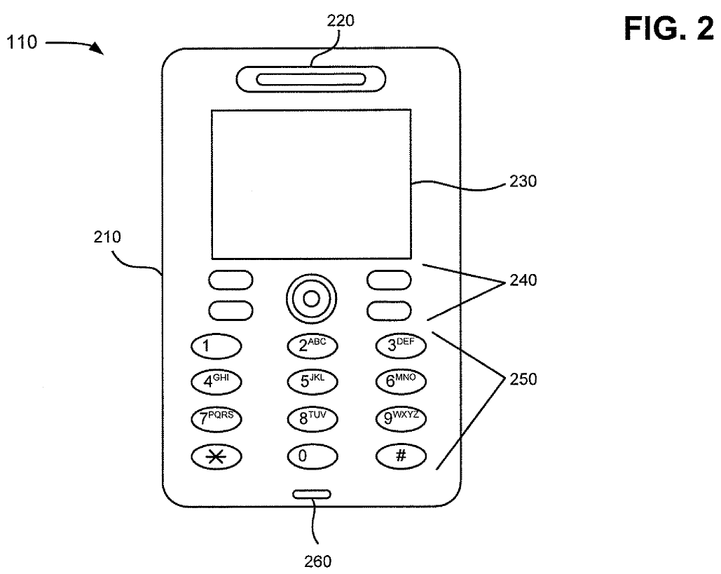

FIG. 2 is an exemplary front view of user device 110 in one implementation described herein. As shown in FIG. 2, user device 110 may include a housing 210, a speaker 220, a display 230, control buttons 240, a keypad 250, and/or a microphone 260. Housing 210 may protect the components of user device 110 from outside elements. Speaker 220 may provide audible information to a user of user device 110.

Display 230 may provide visual information to the user. For example, display 230 may display text input into user device 110, text and/or graphics (e.g., a SMS signal) received from another device, such as server 120, and/or information regarding incoming or outgoing calls or text messages, media, games, phone books, address books, the current time, etc. Control buttons 240 may permit the user to interact with user device 110 to cause user device 110 to perform one or more operations. For example, control buttons 240 may be used to cause user device 110 to transmit information. Keypad 250 may include a standard telephone keypad. Microphone 260 may receive audible information from the user.

Although FIG. 2 shows exemplary elements of user device 110, in other implementations, user device 110 may contain fewer, different, or additional elements than depicted in FIG. 2. In still other implementations, one or more elements of user device 110 may perform the tasks performed by one or more other elements of user device 110.

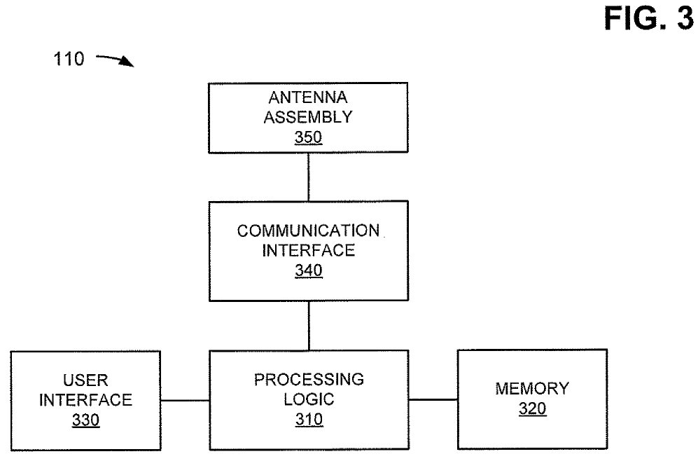

FIG. 3 is a diagram of exemplary components of user device 110. As shown in FIG. 3, user device 110 may include processing logic 310, memory 320, a user interface 330, a communication interface 340, and/or an antenna assembly 350. Processing logic 310 may include a processor, microprocessor, an application specific integrated circuit (ASIC), field programmable gate array (FPGA), or the like. Processing logic 310 may control operation of user device 110 and its components. Memory 320 may include a random access memory (RAM), a read only memory (ROM), and/or another type of memory to store data and instructions that may be used by processing logic 310.

User interface 330 may include mechanisms for inputting information to user device 110 and/or for outputting information from user device 110. Examples of input and output mechanisms might include buttons (e.g., control buttons 240, keys of keypad 250, a joystick, etc.) to permit data and control commands to be input into user device 110; a speaker (e.g., speaker 220) to receive electrical signals and output audio signals; a microphone (e.g., microphone 260) to receive audio signals and output electrical signals; a display (e.g., display 230) to output visual information (e.g., text input into user device 110); and/or a vibrator to cause user device 110 to vibrate.

Communication interface 340 may include, for example, a transmitter that may convert baseband signals from processing logic 310 to radio frequency (RF) signals and/or a receiver that may convert RF signals to baseband signals. Alternatively, communication interface 340 may include a transceiver to perform functions of both a transmitter and a receiver. Communication interface 340 may connect to antenna assembly 350 for transmission and/or reception of the RF signals. Antenna assembly 350 may include one or more antennas to transmit and/or receive RF signals over the air. Antenna assembly 350 may, for example, receive RF signals from communication interface 340 and transmit them over the air and receive RF signals over the air and provide them to communication interface 340. In one implementation, for example, communication interface 340 may communicate with a network, such as network 140.

As will be described in detail below, user device 110 may perform certain operations in response to processing logic 310 executing software instructions of an application contained in a computer-readable medium, such as memory 320. A computer-readable medium may be defined as a physical or logical memory device and/or carrier wave. The software instructions may be read into memory 320 from another computer-readable medium or from another device via communication interface 340. The software instructions contained in memory 320 may cause processing logic 310 to perform processes that will be described later. Alternatively, hardwired circuitry may be used in place of or in combination with software instructions to implement processes described herein. Thus, implementations described herein are not limited to any specific combination of hardware circuitry and software.

Although FIG. 3 shows exemplary components of user device 110, in other implementations, user device 110 may contain fewer, different, or additional components than depicted in FIG. 3. In still other implementations, one or more components of user device 110 may perform the tasks performed by one or more other components of user device 110.

### Exemplary Client/Server Configuration

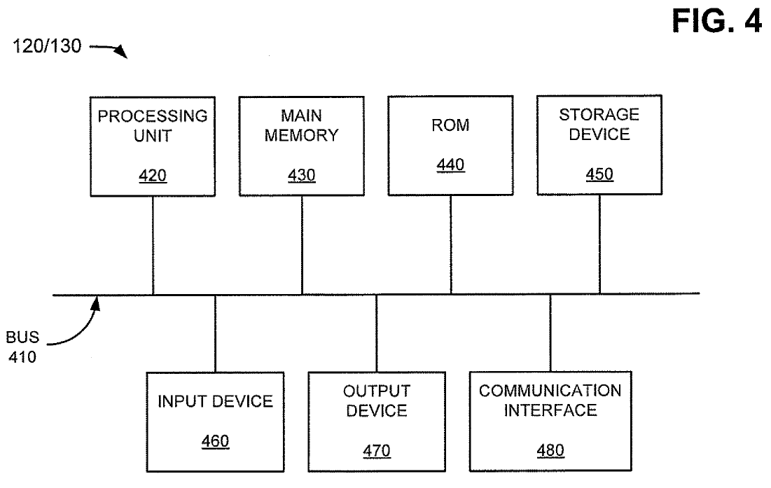

FIG. 4 is an exemplary diagram of a client/server entity corresponding to server 120 or client 130. As illustrated, the client/server entity may include a bus 410, a processing unit 420, a main memory 430, a ROM 440, a storage device 450, an input device 460, an output device 470, and/or a communication interface 480. Bus 410 may include a path that permits communication among the components of the client/server entity.

Processing unit 420 may include a processor, microprocessor, or other type of processing logic that may interpret and execute instructions. Main memory 430 may include a RAM or another type of dynamic storage device that may store information and instructions for execution by processing unit 420. ROM 440 may include a ROM device or another type of static storage device that may store static information and/or instructions for use by processing unit 420. Storage device 450 may include a magnetic and/or optical recording medium and its corresponding drive.

Input device 460 may include a mechanism that permits an operator to input information to the client/server entity, such as a keyboard, a mouse, a pen, a microphone, voice recognition and/or biometric mechanisms, etc. Output device 470 may include a mechanism that outputs information to the operator, including a display, a printer, a speaker, etc. Communication interface 480 may include any transceiver-like mechanism that enables the client/server entity to communicate with other devices and/or systems. For example, communication interface 480 may include mechanisms for communicating with another device or system via a network, such as network 140.

As will be described in detail below, the client/server entity may perform certain operations in response to processing unit 420 executing software instructions contained in a computer-readable medium, such as main memory 430. The software instructions may be read into main memory 430 from another computer-readable medium, such as storage device 450, or from another device via communication interface 480. The software instructions contained in main memory 430 may cause processing unit 420 to perform processes that will be described later. Alternatively, hardwired circuitry may be used in place of or in combination with software instructions to implement processes described herein. Thus, implementations described herein are not limited to any specific combination of hardware circuitry and software.

Although FIG. 4 shows exemplary components of the client/server entity, in other implementations, the client/server entity may contain fewer, different, or additional components than depicted in FIG. 4. In still other implementations, one or more components of the client/server entity may perform the tasks performed by one or more other components of the client/server entity.

### Exemplary Client/Server Operation

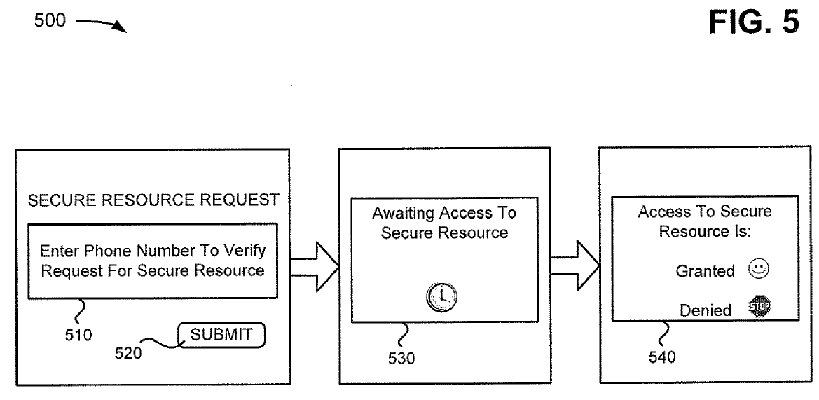

FIG. 5 is a diagram of exemplary displays 500 that may be provided by client 130. As shown to the left in FIG. 5, a user may request access to a secure resource (e.g., provided by server 120) via client 130. For example, a user may request access to a company intranet, a secure server, an application provided within a secure network, a credit or debit card, a building, a vehicle, etc. In the authentication example, client 130 may provide a display that includes a mechanism 510 to enable entry of a verification telephone number, and a submit mechanism 520 to enable submission of the entered verification telephone number. Mechanism 510 may include, for example, an input field, a drop-down menu providing telephone number choices, and/or other similar input mechanisms. Submit mechanism 520 may include a mechanism (e.g., an icon, link, button, and/or other similar selection mechanisms) that may be selected if the user hovers over or clicks on mechanism 520.

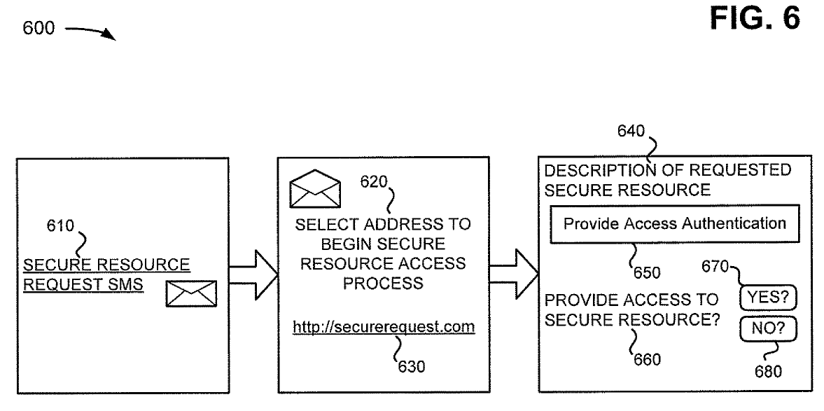

The secure resource request and the verification telephone number input by mechanism 510 may be received by server 120, and server 120 may perform verification functions with user device 110, as described below in connection with FIG. 6. Server 120 may associate the verification telephone number with an authentication mechanism (e.g., a user name, a password, a PIN, etc.). As shown in the middle of FIG. 5, if server 120 is performing verification functions with user device 110, client 130 may display information 530 indicating that client 130 is awaiting access to the secure resource. As shown to the right in FIG. 5, after server 120 has completed the verification functions, client 130 may display information 540 indicating whether access to the secure resource is granted or denied.

Although not shown in FIG. 5, in the transaction example, the user may request approval to use the secure resource (e.g., provided by server 120) via client 130. Server 120 may associate the secure resource with a telephone number and a public key related to user device 110, and may perform verification functions with user device 110, as described below in connection with FIG. 6. If server 120 is performing verification functions with user device 110, client 130 may display information (e.g., similar to information 530) indicating that client 130 is awaiting approval to use the secure resource. For example, if the user is requesting approval of a credit card transaction, client 130 may display information indicating that the credit card transaction is awaiting approval. After server 120 has completed the verification functions, client 130 may display information (e.g., similar to information 540) indicating whether the user is approved to use the secure resource.

Although FIG. 5 shows exemplary displays 500 of client 130, in other implementations, client 130 may provide fewer, different, or additional displays than depicted in FIG. 5. In still other implementations, exemplary displays 500 of FIG. 5 may include fewer, different, or additional elements than depicted in FIG. 5.

### Exemplary User Device/Server Operation

FIG. 6 is a diagram of exemplary displays 600 that may be provided by user device 110. As shown to the left in FIG. 6, if a user requests access to a secure resource (e.g., provided by server 120) via client 130, server 120 may generate a SMS signal (e.g., SMS signal 160 of FIG. 1). In the authentication example, the SMS signal may be received by user device 110 associated with the verification telephone number and the user, and a secure session may be established between user device 110 and server 120. User device 110 may display information 610 (e.g., an icon, a link, etc.) indicating receipt of the SMS signal. If the user of user device 110 selects information 610 (e.g., by hovering over or clicking on information 610), as shown in the middle of FIG. 6, user device 110 may display the contents of the SMS signal. The contents of the SMS signal may include, for example, information 620 requesting the user to select an address 630 (e.g., a Uniform Resource Locator (URL)) to begin a secure resource access verification process.

In the authentication example, the SMS signal may include a description of the requested secure resource and a URL to a downloadable application (e.g., a Java midlet) maintained by server 120. Each downloadable application maintained by server 120 may contain a data segment with a private key field, and the data segment may be encrypted for security purposes (e.g., to prevent hacking). Server 120 may associate a list of verification telephone numbers (e.g., of user devices 110) with corresponding downloadable applications (and their corresponding authentication mechanisms) to create pairs of verification telephone numbers and corresponding authentication mechanisms. If the downloadable application is initiated (e.g., if the user selects address 630), user device 110 may contact server 120 and initiate secure communications with server 120. For example, user device 110 may provide its telephone number to server 120 over a secure socket connection (or other type of secure connection).

If secure communications are established between user device 110 and server 120, server 120 may provide a variety of information to user device 110 to aid in the verification process. For example, as shown to the right in FIG. 6, user device 110 may display information 640 providing a description of the requested secure resource, a mechanism 650 to enable entry of an authentication mechanism, information 660 inquiring whether access to the secure resource is to be granted or denied, and two submission mechanisms (e.g., a YES mechanism 670 and a NO mechanism 680) to enable submission of the entered authentication mechanism as well as a decision of whether access is to be granted or denied. Mechanism 650 may include, for example, an input field, a drop-down menu providing authentication mechanism choices, and/or other similar input mechanisms. Submission mechanisms 670 and 680 may include mechanisms (e.g., icons, links, buttons, and/or other similar selection mechanisms) that may be selected if the user hovers over or clicks on submission mechanisms 670 and 680. In other implementations, the authentication mechanism associated with user device 110 may be automatically generated (e.g., if YES mechanism 670 is selected), and mechanism 650 may be omitted.

If the user of user device 110 wishes to provide access to the secure resource, the user may provide an authentication mechanism (e.g., via mechanism 650 or automatically with user device 110) and may select YES mechanism 670. Server 120 may receive the authentication mechanism from user device 110, and may verify the authentication mechanism in order to determine whether to grant or deny access to the secure resource. For example, server 120 may grant the user, via client 130, access to the secure resource provided by server 120. If the user of user device wishes to deny access to the secure resource, the user may omit providing information via mechanism 650 and/or may select NO mechanism 680. Server 120 may deny access to the secure resource based on this information and/or if the authentication mechanism is not verified.

If the user attempts to access the same secure resource a second time (e.g., the user attempts to log into a secure web site a second time), server 120 may check to see if the downloadable application (e.g., the Java midlet) is running on user device 1 10. If the Java midlet is running on user device 110, the authentication process (e.g., the request for the private key) may begin immediately. If the Java midlet is not running on user device 110, the SMS signal may be sent to user device 110 and the authentication process described above may begin.

Although not shown in FIG. 6, in the transaction example, server 120 may associate the secure resource and/or the secure resource request with a telephone number and a public key related to user device 110. Server 120 may send user device 110 a SMS signal that includes an address (similar to address 630) for establishing a secure session with server 120. If a secure session is established between server 120 and user device 110, server 120 may send user device 110 (and user device 110 may display) a description of the secure resource (similar to information 640), the user (e.g., a person, a device, etc.) requesting approval, a request to approve use of the secure resource by the user (similar to information 660 and submission mechanisms 670 and 680), and/or a random number identifying the request. The secure resource request may be approved, via user device 110, by electronically signing the description of the secure resource with a private key and sending the signed description and the random number to server 120. In other implementations, the secure resource request may be approved with other mechanisms that may utilize the private key for approval purposes.

In order to determine whether to grant or deny access to the secure resource, server 120 may verify the signed description of the secure resource with a public key associated with user device 110 and/or by comparing the received random number with the original random number. For example, if the signed description is verified by server 120, the requester (e.g., via client 130) may receive approval to use the secure resource.

Although implementations described herein discuss pairing the verification telephone numbers with corresponding authentication mechanisms for each downloadable application, in other implementations, such a pairing may be omitted and the user requesting access to the secure resource may provide a key code (e.g., numbers, letters, or a combination of numbers or letters), which may be requested from the verifying user device 110.

Furthermore, although implementations described herein discuss providing a SMS signal, in other implementations, a signal other than a SMS signal may be used. For example, an Internet Protocol (IP) Multimedia Subsystem (IMS) signal, a Jabber signal, or another IP-based signal may be used. If an IP-based signal is used, user device 110 may be automatically connected to server 120 and server 120 may contact user device 110 using an appropriate protocol (e.g., Session Initiation Protocol (SIP) in the case of IMS, Extensible Messaging and Presence Protocol (XMPP) in the case of Jabber, etc.). Use of a SMS signal may be advantageous if the IP address of user device 110 is unknown without user device 110 providing its IP address to server 120. The SMS signal may thus initiate communication between an unknown user device 110 and server 120.

Still further, implementations described herein may be used to transfer a chat session from user device 110 (e.g. a mobile telephone) to client 130 (e.g., a web interface provided on client 130). This may be accomplished by incorporating the implementations described herein into a chat application. If a user wants to transfer the chat to client 130, the user may enter the telephone number of user device 110 on the web interface of client 130, which may trigger a dialog on user device 110 asking the user if he/she wants to transfer the chat to the web interface of client 130.

Although FIG. 6 shows exemplary displays 600 of user device 110, in other implementations, user device 110 may provide fewer, different, or additional displays than depicted in FIG. 6. In still other implementations, exemplary displays 600 of FIG. 6 may include fewer, different, or additional elements than depicted in FIG. 6.

### Exemplary Process

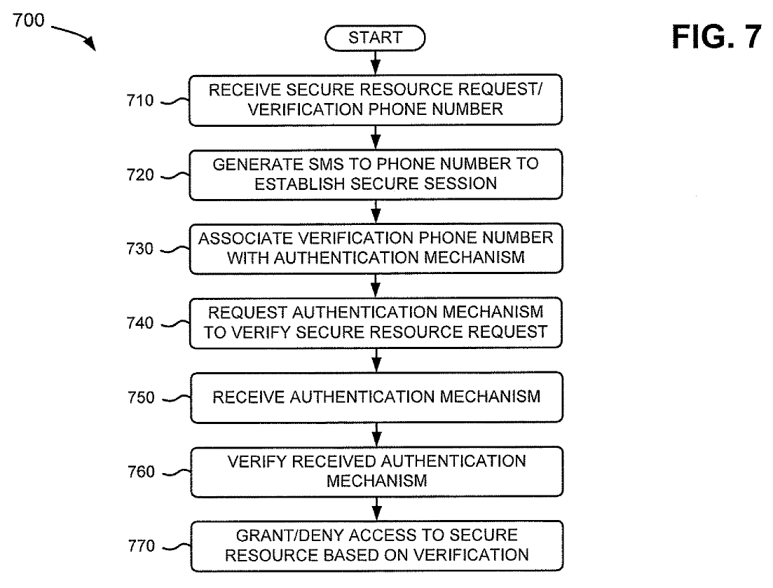

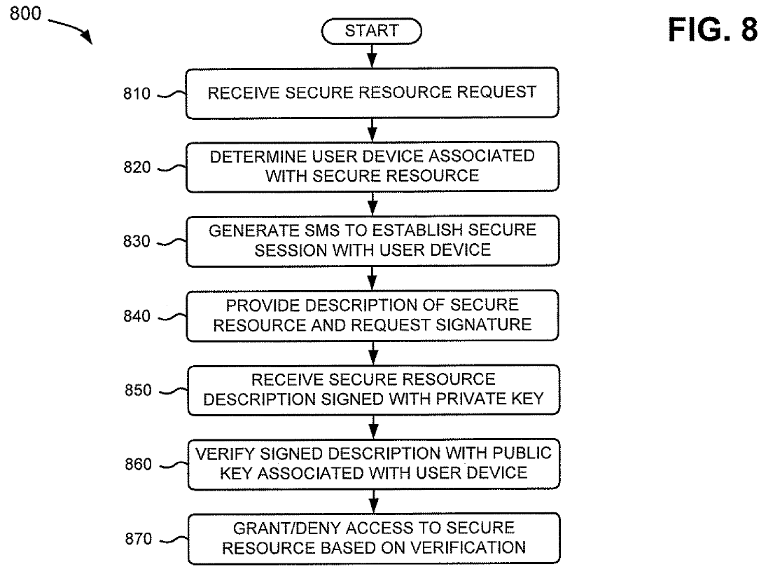

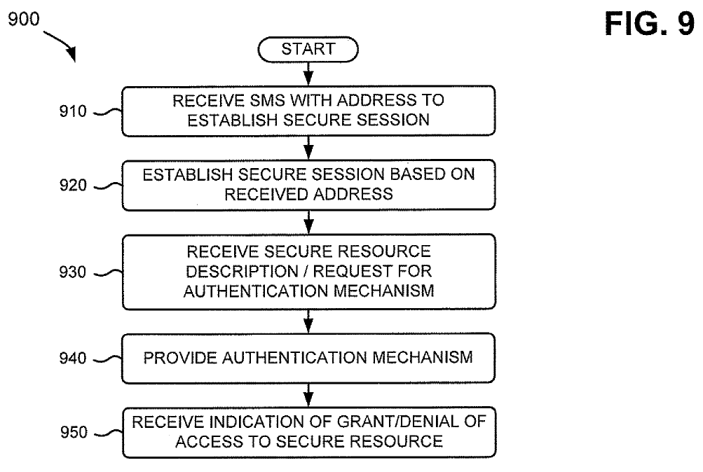

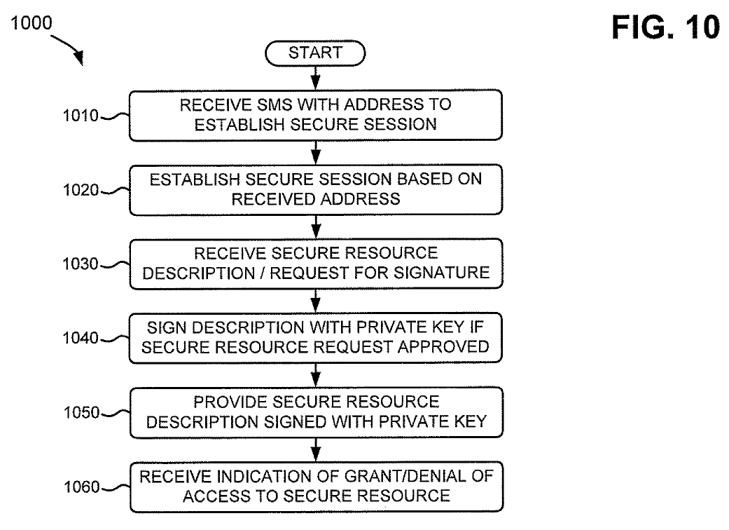

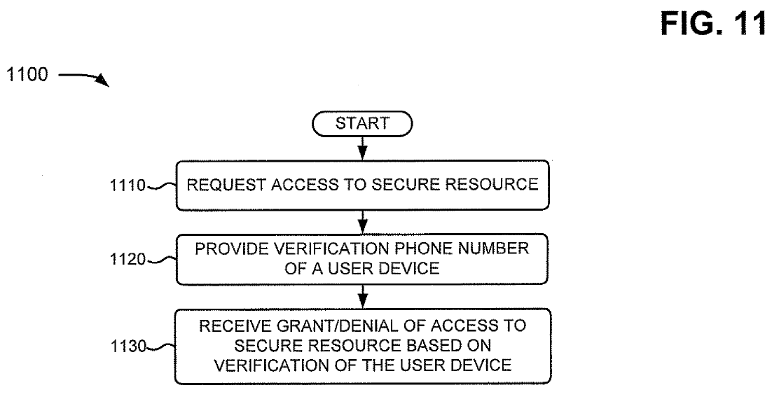

FIGS. 7-11 depict flow charts of exemplary processes according to implementations described herein. Generally, FIG. 7 depicts an exemplary authentication process 700 capable of being performed by server 120, FIG. 8 depicts an exemplary transaction process 800 capable of being performed by server 120, FIG. 9 depicts an exemplary authentication process 900 capable of being performed by user device 110, FIG. 10 depicts an exemplary transaction process 1000 capable of being performed by user device 110, and FIG. 11 depicts an exemplary process 1100 capable of being performed by client 130. Processes 700-1100 may be performed by hardware and/or software components on user device 110, server 120, client 130, or a combination of user device 110, server 120, and/or client 130.

### Authentication Process (Server)

As shown in FIG. 7, process 700 may begin with receipt of a request to access a secure resource and/or a verification telephone number (block 710). For example, in one implementation described above in connection with FIG. 5, the secure resource request and the verification telephone number input by mechanism 510 of client 130 may be received by server 120.

A SMS signal may be generated and sent to the verification telephone number to establish a secure session (block 720). For example, in one implementation described above in connection with FIG. 6, if a user requests access to a secure resource (e.g., provided by server 120) via client 130, server 120 may generate a SMS signal (e.g., SMS signal 160 of FIG. 1). The SMS signal may include, for example, information 620 requesting the user to select address 630 (e.g., a URL) to begin a secure resource access verification process.

As further shown in FIG. 7, the verification telephone number may be associated with an authentication mechanism (block 730). For example, in one implementation described above in connection with FIG. 5, server 120 may associate the verification telephone number with an authentication mechanism (e.g., a user name, a password, a PIN, etc.).

The authentication mechanism may be requested to verify the secure resource request (block 740). For example, in one implementation described above in connection with FIG. 6, if secure communications are established between user device 110 and server 120, server 120 may provide a variety of information to user device 110 to aid in the verification process. In one example, server 120 may provide mechanism 650 to request entry of an authentication mechanism, information 660 inquiring whether access to the secure resource is to be granted or denied, and two submission mechanisms (e.g., YES mechanism 670 and NO mechanism 680) to enable submission of the entered authentication mechanism as well as a decision of whether access is to be granted or denied.

As further shown in FIG. 7, if the authentication mechanism is received (block 750), the authentication mechanism may be verified (block 760) and access to the secure resource may be granted based on the verification (block 770). For example, in one implementation described above in connection with FIG. 6, if the user of user device 110 wishes to provide access to the secure resource, the user may provide the authentication mechanism (e.g., via mechanism 650 or automatically with user device 110). Server 120 may receive the authentication mechanism from user device 110, and may verify the authentication mechanism by, for example, comparing the received authentication mechanism with the authentication mechanism associated with the verification telephone number. Server 120 may determine whether to grant or deny access to the secure resource based on the results of verification of the authentication mechanism.

### Transaction Process (Server)

As shown in FIG. 8, process 800 may begin with receipt of request to approve access to a secure resource (block 810). For example, in one implementation described above in connection with FIG. 1, client 130 may send request 150 to request access to a secure resource to server 120.

A user device associated with the secure resource may be determined (block 820). For example, in one implementation described above in connection with FIG. 6, server 120 may associate the secure resource with a telephone number and a public key related to user device 110.

As further shown in FIG. 8, a SMS signal may be generated to establish a secure session with the user device (block 830). For example, in one implementation described above in connection with FIG. 6, server 120 may send user device 110 a SMS signal that includes an address for establishing a secure session with server 120. The SMS signal may include, for example, information 620 requesting the user to select address 630 (e.g., a URL) to begin a secure resource access verification process.

A description of the secure resource and a request for signature may be provided (block 840). For example, in one implementation described above in connection with FIG. 6, if a secure session is established between server 120 and user device 110, server 120 may send user device 110 (and user device 110 may display) a description of the secure resource (similar to information 640), the user (e.g., a person, a device, etc.) requesting approval, a request to approve use of the secure resource by the user (similar to information 660 and submission mechanisms 670 and 680), and/or a random number identifying the request.

As further shown in FIG. 8, if the secure resource description signed with a private key is received (block 850), the signed description may be verified with a public key associated with the user device (block 860) and approval to use the secure resource may be granted or denied based on the verification (block 870). For example, in one implementation described above in connection with FIG. 6, the secure resource request may be approved, via user device 110, by electronically signing the description of the secure resource with a private key and sending the signed description and the random number to server 120. In order to determine whether to grant or deny access to the secure resource, server 120 may verify the signed description of the secure resource with the public key associated with user device 110 and/or by comparing the received random number with the original random number. Server 120 may grant or deny approval to use the secure resource based on the results of the verifications performed by server 120.

### Authentication Process (User Device)

As shown in FIG. 9, process 900 may begin with receipt of a SMS signal containing an address to establish a secure session (block 910). For example, in one implementation described above in connection with FIG. 6, the SMS signal may be received by user device 110 associated with the verification telephone number and the user. User device 110 may display information 610 (e.g., an icon, a link, etc.) indicating receipt of the SMS signal. If the user of user device 110 selects information 610 (e.g., by hovering over or clicking on information 610), user device 110 may display, for example, information 620 requesting the user to select address 630 (e.g., a URL) to begin a secure resource access verification process.

If a secure session is establish based on the received address (block 920), a description of a secure resource to be accessed and/or a request for an authentication mechanism may be received (block 930). For example, in one implementation described above in connection with FIG. 6, the URL may provide an address to a downloadable application (e.g., a Java midlet) maintained by server 120. If the downloadable application is initiated (e.g., if the user selects address 630), user device 110 may contact server 120 and initiate secure communications with server 120 (e.g., user device 110 may provide its telephone number to server 120 over a secure socket connection). If secure communications are established between user device 110 and server 120, user device 110 may receive information 640 providing a description of the requested secure resource, and a request (e.g., mechanism 650) for entry of an authentication mechanism.

As further shown in FIG. 9, if the authentication mechanism is provided (block 940), an indication of whether to grant or deny access to the secure resource may be received (block 950). For example, in one implementation described above in connection with FIG. 6, if the user of user device 110 wishes to grant access to the secure resource, the user may provide an authentication mechanism (e.g., via mechanism 650 or automatically with user device 110). Server 120 may receive the authentication mechanism from user device 110, and may verify the authentication mechanism in order to determine whether to grant or deny access to the secure resource. In other implementations, user device 110 may receive (e.g., from server 120) an indication of whether access to the secure resource has been granted or denied.

### Transaction Process (User Device)

As shown in FIG. 10, process 1000 may begin with receipt of a SMS signal containing an address to establish a secure session (block 1010). For example, in one implementation described above in connection with FIG. 6, the SMS signal may be received by user device 110 associated with the secure resource requested. User device 110 may display information 610 (e.g., an icon, a link, etc.) indicating receipt of the SMS signal. If the user of user device 110 selects information 610 (e.g., by hovering over or clicking on information 610), user device 110 may display, for example, information 620 requesting the user to select address 630 (e.g., a URL) to begin a secure resource access verification process.

If a secure session is establish based on the received address (block 1020), a description of a secure resource to be accessed and/or a request for a signature may be received (block 1030). For example, in one implementation described above in connection with FIG. 6, if a secure session is established between server 120 and user device 110, server 120 may send user device 110 (and user device 110 may display) a description of the secure resource (similar to information 640), the user (e.g., a person, a device, etc.) requesting approval, a request to approve (e.g., via signature with a private key) use of the secure resource by the user (similar to information 660 and submission mechanisms 670 and 680), and/or a random number identifying the request.

As further shown in FIG. 10, the secure resource description may be signed with a private key if the secure resource request is to be approved (block 1040). For example, in one implementation described above in connection with FIG. 6, the secure resource request may be approved, via user device 110, by electronically signing the description of the secure resource with the private key.

The secure resource description signed with the private key may be provided (block 1050), and an indication of whether to grant or deny access to the secure resource may be received (block 1060). For example, in one implementation described above in connection with FIG. 6, user device 110 may send the signed description and the random number to server 120. Server 120 may verify the signed description of the secure resource with a public key associated with user device 110 and/or by comparing the received random number with the original random number. In other implementations, user device 110 may receive (e.g., from server 120) an indication of whether approval to access the secure resource has been granted or denied.

### Authentication/Transaction Process (Client)

As shown in FIG. 11, process 1100 may begin with sending a request to access a secure resource (block 1110). For example, in one implementation described above in connection with FIG. 5 (e.g., the authentication and transaction examples), a user may request access to a secure resource (e.g., provided by server 120) via client 130. In one example, a user may request access to a company intranet, a secure server, an application provided within a secure network, a credit or debit card, a building, a vehicle, etc.

A verification telephone number of a user device may be provided (block 1120). For example, in one implementation described above in connection with FIG. 5 (e.g., the authentication example), client 130 may provide a display that includes mechanism 510 to enable entry of the verification telephone number, and submit mechanism 520 to enable submission of the entered verification telephone number. The secure resource request and the verification telephone number input by mechanism 510 may be received by server 120, and server 120 may perform verification functions with user device 110. In the transaction example, a verification telephone number need not be provided because server 120 may associate the requested secure resource with a telephone number and a public key related to user device 110, and may perform verification functions with user device 110.

As further shown in FIG. 11, access or denial of access to the secure resource may be received based on verification of the user device (block 1130). For example, in one implementation described above in connection with FIG. 5 (e.g., the authentication and transaction examples), after server 120 has completed the verification functions, client 130 may receive (e.g., from server 120) and display information 540 indicating whether access to the secure resource is granted or denied and/or indicating whether the user is approved to use the secure resource.

### CONCLUSION

Implementations described herein may provide access to one or more secure resources based on authentication and/or authorization provided by a secure user device. For example, in one implementation, the user device may correspond to a cellular or mobile telephone capable of supporting a PKI. The user device may include two sets of PKI credentials that provide authentication and/or authorization for another device attempting to access a secure resource. Implementations described herein may provide simple and secure systems and methods for accessing any secure resource, without the need to remember multiple passwords, user names, etc.

The foregoing description of implementations provides illustration and description, but is not intended to be exhaustive or to limit the invention to the precise form disclosed. Modifications and variations are possible in light of the above teachings or may be acquired from practice of the invention.

For example, while a series of acts has been described with regard to FIGS. 7-11, the order of the acts may be modified in other implementations. Further, non-dependent acts may be performed in parallel.

Also, the term “user” has been used herein. The term “user” is intended to be broadly interpreted to include a client and/or a user device or a user of a client and/or user device.

It will be apparent that aspects, as described above, may be implemented in many different forms of software, firmware, and hardware in the implementations illustrated in the figures. The actual software code or specialized control hardware used to implement these aspects should not be construed as limiting. Thus, the operation and behavior of the aspects were described without reference to the specific software code--it being understood that software and control hardware could be designed to implement the aspects based on the description herein.

No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A method, comprising:
receiving a request to access a secure resource and a verification telephone number from a first device;
establishing a secure session with a second device associated with the verification telephone number;
requesting an authentication mechanism from the second device to verify the secure resource request;
verifying the received authentication mechanism if the requested authentication mechanism is received from the second device; and
determining whether to grant or deny the first device access to the secure resource based on the verification of the received authentication mechanism.

2. The method of claim 1, further comprising:
associating the verification telephone number with the authentication mechanism.

3. The method of claim 1, wherein establishing a secure session comprises:
generating a Short Message Service (SMS) signal that includes an address for establishing the secure session;
providing the SMS signal to the second device; and
establishing the secure session if the second device accesses the address.

4. The method of claim 1, wherein verifying the received authentication mechanism comprises:
determining whether the received authentication mechanism matches an authentication mechanism associated with the verification telephone number.

5. A method, comprising:
receiving a request to use a secure resource;
determining a device associated with the secure resource;
establishing a secure session with the device associated with the secure resource;
requesting approval of the secure resource request from the device;
verifying the approval if the approval of the secure resource request is received from the device; and
determining whether to grant or deny the first device use of the secure resource based on the verification of the approval.

6. The method of claim 5, wherein establishing a secure session comprises:
generating a Short Message Service (SMS) signal that includes an address for establishing the secure session;
providing the SMS signal to the device; and
establishing the secure session if the device accesses the address.

7. The method of claim 5, wherein requesting approval comprises:
providing a description of the secure resource to the device; and
requesting signature of the description by the device with a private key.

8. The method of claim 5, wherein verifying the approval comprises:
verifying the approval with a public key associated with the device.

9. A method implemented within a first device, comprising:
receiving a Short Message Service (SMS) signal that includes an address for establishing a secure session to authenticate a request to access a secure resource by a second device;
establishing the secure session based on the address;
receiving a request for an authentication mechanism to authenticate the secure resource request; and
providing the requested authentication mechanism if the secure resource request is to be authenticated.

10. The method of claim 9, further comprising:
receiving an indication of whether access to the secure resource is granted or denied to the second device.

11. The method of claim 9, wherein receiving a request for an authentication mechanism comprises:
receiving a description of the secure resource.

12. A method implemented within a first device, comprising:
receiving a Short Message Service (SMS) signal that includes an address for establishing a secure session to approve a request to use a secure resource by a second device;
establishing the secure session based on the address;
receiving a request for approval of the secure resource request; and
providing the requested approval if the secure resource request is to be approved.

13. The method of claim 12, further comprising:
receiving an indication of whether approval to use the secure resource is granted or denied to the second device.

14. The method of claim 12, wherein receiving a request for approval comprises:
receiving a description of the secure resource; and
receiving a request for signature of the description with a private key.

15. The method of claim 14, wherein providing the requested approval comprises:
providing the description signed with the private key if the secure resource request is to be approved.

16. The method of claim 12, wherein receiving a request for approval comprises at least one of:
receiving a description of the secure resource;
receiving an identification of a user requesting use of the secure resource; or
receiving a random number identifying the secure resource request.

17. A method implemented within a first device, comprising:
requesting access to or use of a secure resource;
providing a verification telephone number identifying a second device, the second device authenticating the first device for access to or use of the secure resource; and
receiving access to or use of the secure resource based on the authentication provided by the second device.

18. A system, comprising:
means for receiving a request to access a secure resource from a first device;
means for establishing a secure session, via a Short Message Service (SMS) signal, with a second, different device to authorize access to the secure resource;
means for requesting approval of the secure resource request from the second device;
means for verifying the approval if the approval of the secure resource request is received from the second device; and
means for determining whether to grant or deny the first device access to the secure resource based on the verification of the approval.

19. The system of claim 18, wherein the means for requesting approval comprises one of:
means for requesting an authentication mechanism from the second device to verify the secure resource request; or
means for requesting signature of a description of the secure resource by the second device with a private key.

20. The system of claim 18, wherein the means for verifying the approval comprises one of:
means for determining whether an authentication mechanism received from the second device matches an authentication mechanism associated with a verification telephone number of the second device; or
means for verifying the approval with a public key associated with the second device.

21. A system, comprising:
means for receiving a Short Message Service (SMS) signal that includes an address for establishing a secure session to authenticate a request to access a secure resource by a second device;
means for establishing the secure session based on the address;
means for receiving a request for approval of the secure resource request; and
means for providing the requested approval if the secure resource request is to be approved.

22. The system of claim 21, wherein the means for receiving a request comprises:
means for receiving a request for an authentication mechanism to authenticate the secure resource request.

23. The system of claim 22, wherein the means for providing the requested approval comprises:
means for providing the requested authentication mechanism if the secure resource request is to be authenticated.

24. The system of claim 21, wherein the means for receiving a request for approval comprises:
means for receiving a description of the secure resource and at least one of an identification of a user requesting use of the secure resource or a random number identifying the secure resource request; and
means for receiving a request for signature of the description with a private key.

25. The system of claim 24, wherein the means for providing the requested approval comprises:
means for providing the description signed with the private key if the secure resource request is to be approved.

26. A device, comprising:
a memory to store a plurality of instructions; and
a processor to execute instructions in the memory to:
receive a request to access a secure resource from a first device,
establish a secure session, via a Short Message Service (SMS) signal, with a second, different device to authorize access to the secure resource,
request approval of the secure resource request from the second device,
verify the approval if the approval of the secure resource request is received from the second device, and
determine whether to grant or deny the first device access to the secure resource based on the verification of the approval.

27. A device, comprising:
a memory to store a plurality of instructions; and
processing logic to execute instructions in the memory to:
receive a Short Message Service (SMS) signal that includes an address for establishing a secure session to authenticate a request to access a secure resource by a second device,
establish the secure session based on the address,
receive a request for approval of the secure resource request, and
provide the requested approval if the secure resource request is to be approved.
